(19) United States
(12) Patent Application Publication
(10) Pub. No.: US 2012/0173272 A1
(43) Pub. Date: Jul. 5, 2012

(54) Automated System and Method for Processing Obesity Patients

(76) Inventor: Julian Omidi, Las Vegas, NV (US)

(21) Appl. No.: 13/341,930

(22) Filed: Dec. 31, 2011

Related U.S. Application Data
(60) Provisional application No. 61/429,003, filed on Dec. 31, 2010.

(51) Int. Cl. G06Q 50/22

(52) U.S. Cl. 705/2

(57) ABSTRACT

The present invention is comprised of automated system and method for processing an obesity patient for automating the processing of an obesity patient desiring a weight loss medical procedure. The present invention is further comprised of a health insurance plan processing module to automatically verify insurance plan approval of a weight loss medical procedure. The present invention is further comprised of one or more customized automated modules to record and process information that is shared by processing participants.

### BACKGROUND

Obesity has increased as a percentage of the population to the point where some are calling it an epidemic. Public service announcements and government programs asking people to exercise more and eat healthier has failed to stem the tide of the overweight conditions. Advances in medical treatments for people classified as obese has increased during the past few decades. However the health care landscape has become more complex. Health insurance plans vary widely in allowable treatments and patient cost sharing. Health care centers and professionals face a daunting task in maneuvering to get paid for services rendered. Obese people seeking the benefits of the advanced treatments available face dealing with multiple independent organizations, agencies, insurance companies and government health care programs. Many get confused and frustrated and give up trying to get treatment and worse give up hope. What would assist the potential obese patient is a coordinated consortium of organizations and agencies to guide them along through the process of getting treatment.

### BRIEF DESCRIPTION OF THE DRAWINGS

FIG. 1 shows a block diagram of an overview of an automated system and method for processing an obesity patient of one embodiment of the present invention.

FIG. 2 shows a block diagram of an overview flow chart of an automated system and method for processing an obesity patient and continues on FIG. 3 and FIG. 4 of one embodiment of the present invention.

FIG. 3 shows a block diagram of an overview flow chart of obesity patient processing continuing from FIG. 2 of one embodiment of the present invention.

FIG. 4 shows a block diagram of an overview flow chart of medical procedure processing continuing from FIG. 2 of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of an automated system and method for processing an obesity patient a lap band obesity patient procedure is described for illustrative purposes and the underlying system can apply to all types obesity patient procedures for example a gastric bypass procedure or accompanying plastic surgery to remove excess tissue after major weight reduction. In one embodiment of the present invention, the automated system and method for processing an obesity patient may include dermatological treatments to relieve skin irritation due to major weight loss. The an automated system and method for processing an obesity patient can be configured to include services that deal with obesity patient insurance plan change consultations and can be configured to provide nutritional consultations to determine a suitable dietary plan using the present invention.

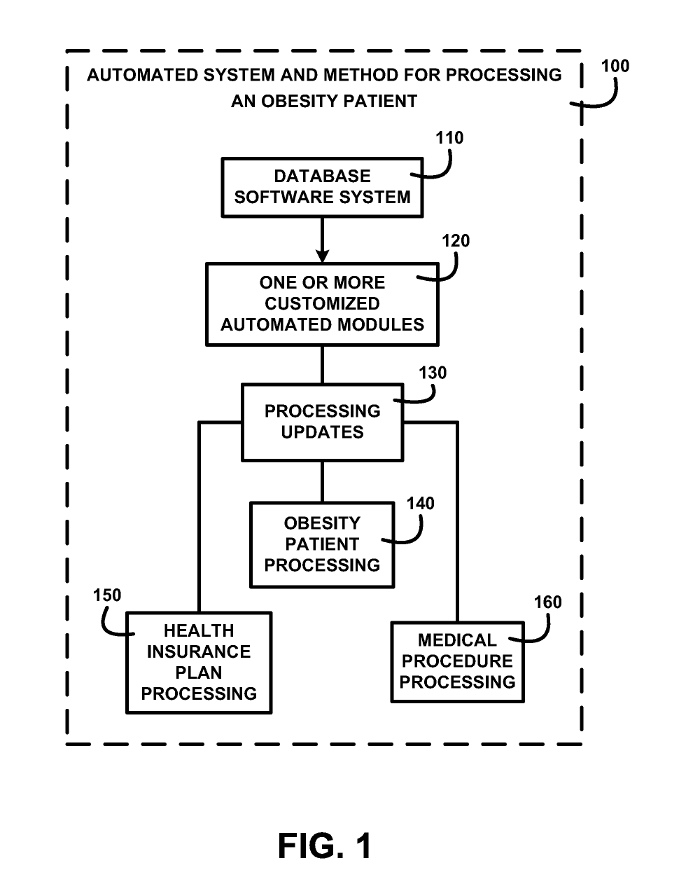

FIG. 1 shows a block diagram of an overview of an automated system and method for processing an obesity patient of one embodiment of the present invention. FIG. 1 shows an automated system and method for processing an obesity patient 100 to receive a medical procedure to reduce their weight significantly to sub obese levels and improve their overall health. The an automated system and method for processing an obesity patient 100 can be configured to include a database software system 110 for recording, storing and retrieving information for example obesity patient contact and heath insurance information. The database software system 110 can be configured to include one or more customized automated modules 120 configured to use computer programming to for example standardize data entry storage and retrieval of one embodiment of the present invention.

The one or more customized automated modules 120 can be used to collect data on processing events, status and scheduling progress. The one or more customized automated modules 120 can be configured to automate scheduling of projected completion dates of various processing stages at initiation of an obesity patient enrollment. When actual task completion dates are entered and recorded the processing updates 130 automated module can be configured to automatically track and readjust the remaining projected completion dates and generate a report of the current processing status to the various participants of one embodiment of the present invention.

The one or more customized automated modules 120 can be configured to automate obesity patient processing 140 to enroll an obesity patient in processing to receive a weight loss medical procedure for example a lap band procedure to effect a loss of weight. The obesity patient processing 140 can be configured to input the obesity patient contact and insurance plan information. The obesity patient processing 140 can be configured to verify procedure approval and record the progress of the processing on the database software system 110. Access to the database software system 110 allows information sharing among the participants for their use in scheduling and evaluating the progress of one embodiment of the present invention.

The one or more customized automated modules 120 can be configured to include an automated health insurance plan processing 150 module to confirm the identification of the correct insurance plan. The automated health insurance plan processing 150 module can process an electronic verification that the insurance plan will cover the cost of the proposed procedure and preoperative screening procedures. The automated health insurance plan processing 150 module can be configured to and record the progress of the processing on the database software system 110 and report the progress to participants of one embodiment of the present invention.

The one or more customized automated modules 120 can be configured to include automated medical procedure processing 160 modules to for example schedule medical appointment once insurance approval is received. The automated medical procedure processing 160 modules can be configured to automatically prepare billings for the various procedures and process the billings to the insurance plan electronically.

The automated system and method for processing an obesity patient 100 using one or more customized automated modules 120 can expedite the processing of an obesity patient at a faster pace and automatically report to the participant the processing progress allowing participants to make adjust in future process schedule in advance. The information sharing made possible by the automated system and method for processing an obesity patient 100 using an automated database software system 110 entry and retrieval system provide all participants with the information thereby saving time that might be used to collect duplications of the same data already collected of one embodiment of the present invention.

### Detailed Operation:

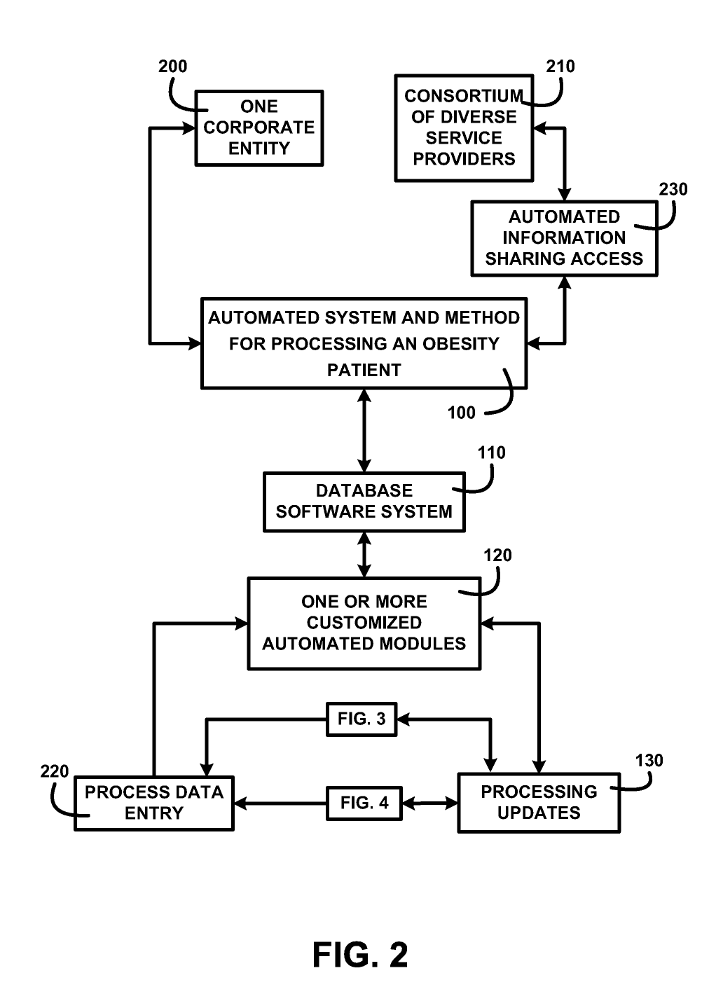

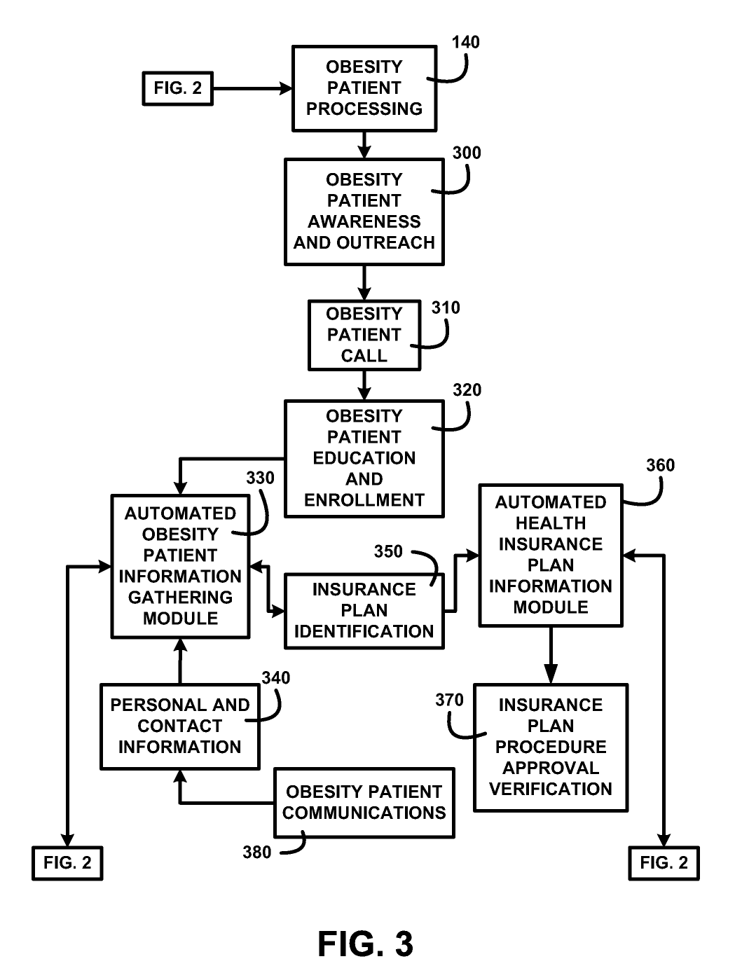

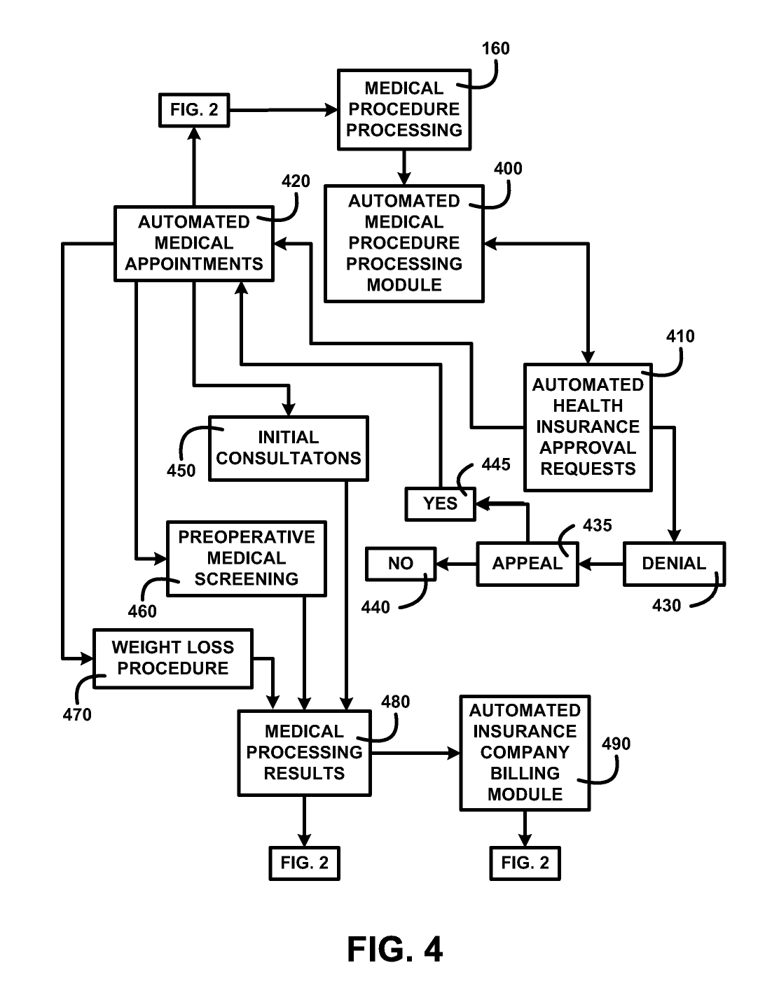

FIG. 2 shows a block diagram of an overview flow chart of an automated system and method for processing an obesity patient and continues on FIG. 3 and FIG. 4 of one embodiment of the present invention. FIG. 2 shows the automated system and method for processing an obesity patient of FIG. 1 that can be used by one corporate entity 200 or a consortium of diverse service providers 210 providing weight loss programs for obesity patients. The automated system and method for processing an obesity patient 100 makes information sharing and progress reports available to all participants in any organizational arrangement. The time savings, better coordination and automated processes allows the ultimate goal of providing life changing medical procedures to an obese person to be reach sooner of one embodiment of the present invention.

The automated system and method for processing an obesity patient can be configured to include the database software system 110 to allow participants to use the automated information sharing access 230 to keep the process on track and to adjust in a timely manner if any impediment to the process occurs. The database software system 110 can be configured to include one or more customized automated modules 120 to allow automation to all of the process phases to reduce manpower and cost in administering the overall process. The one or more customized automated modules 120 can be configured to include processing updates 130 of the progress and automatically notify participants of any schedule changes well in advance of one embodiment of the present invention

The one or more customized automated modules 120 can be configured to include process data entry 220 to record and store information for example related to the obesity patient, the insurance coverage and appointments. The process data entry 220 modules can be configured to standardize how the information is collected and format the information automatically to make it accessible for other automated processes. The processing updates 130 and process data entry 220 modules create gateway for the other automated process modules that continue and are described in FIG. 3 and FIG. 4 of one embodiment of the present invention.

### Obesity Patient Processing:

FIG. 3 shows a block diagram of an overview flow chart of obesity patient processing continuing from FIG. 2 of one embodiment of the present invention. FIG. 3 shows the continuation of the automated system and method for processing an obesity patient 100 of FIG. 1 processing from FIG. 2. The obesity patient processing 140 can be configured to include obesity patient awareness and outreach 300. The obesity patient awareness and outreach 300 can be configured to include marketing and advertising to let obese persons to become aware that these process services are available as well as invite them to receive informative procedure details. Access to knowledgeable well coordinated assistance can relieve the anxiety and confusion of which medical procedure will produce the desired results sought by a potential obesity patient of one embodiment of the present invention.

The advertising will instruct the person to make an obesity patient call 310 to schedule a consultation with experts specializing in weight loss procedures. The consultation will provide obesity patient education and enrollment 320 services to allow the obesity patient to begin processing their medical procedure. The consultation will personnel will use an automated obesity patient information gathering module 330 to collect from the obesity patient personal and contact information 340 and insurance plan identification 350 which will be entered into the database software system 110 of FIG. 1 using the process data entry 220 modules of FIG. 2 and be immediately available to all participants of one embodiment of the present invention.

The insurance plan identification 350 information is automatically transmitted to an automated health insurance plan information module 360 to perform a search to determine whether an insurance plan procedure approval verification 370 is available for the desire procedure. The automated health insurance plan information module 360 automatically records the results of the insurance plan procedure approval verification 370 through the process data entry 220 of FIG. 2. The automated obesity patient information gathering module 330 is used to record obesity patient communications 380 during the entire course of the processing to make that information and any obesity patient concerns can be responded to by designated participants to keep the obesity patient on track. The automated system and method for processing an obesity patient 100 also provides automated processing methods to increase obesity patient awareness and education of procedures such as the lap band procedure and guidance on receiving insurance carrier authorization for payment of medical evaluations and procedures of one embodiment of the present invention.

### Medical Procedure Processing:

FIG. 4 shows a block diagram of an overview flow chart of medical procedure processing continuing from FIG. 2 of one embodiment of the present invention. FIG. 4 shows the continuation of the automated system and method for processing an obesity patient 100 of FIG. 1 processing from FIG. 2. The process continues with the medical procedure processing 160 using an automated medical procedure processing module 400. The automated medical procedure processing module 400 processes automated health insurance approval requests 410 to determine whether the insurance carrier will pay for the procedures to be scheduled. If the results of the automated health insurance approval requests 410 is positive and approval is given an automated medical appointments 420 books the first available appointment for the obesity patient and reports the insurance approval and appointment through the processing updates 130 of FIG. 2 modules of one embodiment of the present invention.

If the results of the automated health insurance approval requests 410 is a denial 430 the automated medical procedure processing module 400 automatically prepares an appeal 435 and files it electronically with the insurance company. The results of the appeal 435 could be no 440 which would stop the processing. If the result of the appeal 435 is yes 445 then the automated medical appointments 420 books the first available appointment for initial consultations 450. The initial consultations 450 will further evaluate the obesity patient condition to determine whether a letter of medical necessity can be sent to the insurance company. If the letter of medical necessity can be sent then the automated medical appointments 420 system will book the first available appointment for preoperative medical screening 460 of one embodiment of the present invention.

The preoperative medical screening 460 will review any conditions for example a cardiac problem that might put the obesity patient at a higher risk for surgery. If the preoperative medical screening 460 shows the obesity patient is ready for surgery then the automated medical appointments 420 system will book the first available appointment for a weight loss procedure 470. Upon the completion of each procedure the medical processing results 480 will be posted on the database software system 110 of FIG. 1 of one embodiment of the present invention.

The medical procedure processing 160 system can be configured to include an automated insurance company billing module 490. The automated insurance company billing module 490 upon receiving the medical processing results 480 prepares the billing invoices for the insurance company and sends the invoice automatically to the insurance company electronically and a copy to the database software system 110. When the obesity patient has completed the weight loss procedure 470 they be scheduled and tracked through the recovery period which for example for a lap band is less than one week. The automated system and method for processing an obesity patient 100 of FIG. 1 will continue to process follow up visits for example to adjust the lap band of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An automated system and method for processing an obesity patient to automate the processes of patient enrollment, education, medical evaluation and undergoing a medical procedure, comprising:
a database software system to record, store and retrieve information for example obesity patient contact and heath insurance information;
one or more customized automated modules to automate obesity patient processing to enroll an obesity patient in processing to receive a weight loss medical procedure;
a processing updates automated module to automatically track and readjust the remaining projected completion dates and generate a report of the current processing status to the various participants;
an obesity patient processing to input the obesity patient contact and insurance plan information;
a health insurance plan processing to confirm the identification of the correct insurance plan and process an electronic verification that the insurance plan will cover the cost of the proposed procedure; and;
a medical procedure processing to automatically schedule medical appointments once insurance approval is received.

2. The system of claim 1, wherein the automated system and method for processing an obesity patient is configured to include automated information sharing access for processing participants.

3. The system of claim 1, wherein the automated system and method for processing an obesity patient is configured to include obesity patient awareness and outreach methods to assist an obesity patient in enrolling into a weight loss procedure process.

4. The system of claim 1, wherein the automated system and method for processing an obesity patient is configured to include a obesity patient communications recording system to record and store transcripts of telephonic communication and scanned images of written communications on the database software system.

5. The system of claim 1, wherein the one or more customized automated modules are configured to include processing updates from any other customized automated module.
